(19) United States
(12) Patent Application Publication
(10) Pub. No.: US 2017/0109756 A1
(43) Pub. Date: Apr. 20, 2017

(54) User Unsubscription Prediction Method and Apparatus

(71) Applicant: Huawei Technologies Co., Ltd., Shenzhen (CN)

(72) Inventors: Jia Zeng, Hong Kong (CN); Mingxuan Yuan, HK (CN); Wenyuan Dai, Shenzhen (CN)

(21) Appl. No.: 15/392,698

(22) Filed: Dec. 28, 2016

Related U.S. Application Data
(63) Continuation of application No. PCT/CN2015/073872, filed on Mar. 9, 2015.

(30) Foreign Application Priority Data
Jul. 30, 2014 (CN) 201410371307.2

(51) Int. Cl. G06Q 30/00; G06N 99/00; H04L 29/08

(52) U.S. Cl. CPC G06Q 30/01; H04L 67/22; G06N 99/005; H04M 2215/0188; H04M 2215/32; G06Q 50/01

(57) ABSTRACT

A user unsubscription prediction method and apparatus includes obtaining service consumption feature data, position activity feature data, and social network feature data of a user within a first preset time period, where the position activity feature data refers to data related to communication between the user and each base station within the first preset time period, and the social network feature data refers to data related to communication between the user and another user in a social network within the first preset time period, and inputting the obtained service consumption feature data, position activity feature data, and social network feature data to a pretrained classifier for calculation and outputting a calculation result, where the calculation result is a user unsubscription prediction result.

### CROSS-REFERENCE TO RELATED APPLICATIONS

This application is a continuation of International Patent Application No. PCT/CN2015/073872, filed on Mar. 9, 2015, which claims priority to Chinese Patent Application No. 201410371307.2, filed on Jul. 30, 2014. The disclosures of the aforementioned applications are hereby incorporated by reference in their entireties.

### TECHNICAL FIELD

Embodiments of the present application relate to the field of communications technologies, and in particular, to a user unsubscription prediction method and apparatus.

### BACKGROUND

It is vitally important for most enterprises based on a network access service to predict whether a user unsubscribes in the future and a main reason why the user unsubscribes. For example, a telecommunications operator is extremely concerned about whether a subscribed user of the telecommunications carrier may unsubscribe in the future and when and why the subscribed user unsubscribes, and then, the operator further sustains and retains, according to the results, the user that may unsubscribe accordingly, thereby ensuring values of inventory users and continuing to provide a stable profit for the telecommunications operator. Generally, an operator expects to predict in advance that a user tends to unsubscribe such that the operator has enough time to sustain and retain the user.

An existing user unsubscription prediction technology is mainly based on early service consumption feature data of a user. The data may be from a bill, a call detail record, and the like of the user, for example, daily call duration, daily used data traffic, a quantity of sent short message service (SMS) messages, and a monthly consumption amount of the user. However, the data cannot fully reflect unsubscription features of a user and it generally cannot be predicted accurately whether the user unsubscribes in the future. For example, within six months before the user cancels a subscription service, daily call duration, daily used data traffic, a quantity of sent SMS messages, and a monthly consumption amount of the user may change slightly, and therefore, it is difficult to predict a status of the user six months later.

### SUMMARY

In view of this, embodiments of the present application provide a user unsubscription prediction method and apparatus in order to improve user unsubscription prediction accuracy.

According to a first aspect, an embodiment of the present application provides a user unsubscription prediction method, including obtaining service consumption feature data, position activity feature data, and social network feature data of a user within a first preset time period, where the position activity feature data refers to data related to communication between the user and each base station within the first preset time period, and the social network feature data refers to data related to communication between the user and another user in a social network within the first preset time period, and inputting the obtained service consumption feature data, position activity feature data, and social network feature data to a pretrained classifier for calculation and outputting a calculation result, where the calculation result is a user unsubscription prediction result.

With reference to the first aspect, in a first implementation manner of the first aspect, obtaining position activity feature data of a user within a first preset time period includes extracting the position activity feature data of the user from a position activity feature matrix, where the position activity feature matrix is a matrix formed of data related to communication between each user and each base station within the first preset time period.

With reference to the first aspect or the first implementation manner of the first aspect, in a second implementation manner of the first aspect, obtaining social network feature data of a user within a first preset time period includes extracting the social network feature data of the user from a social network feature matrix, where the social network feature matrix is a matrix formed of data related to communication between users in the social network within the first preset time period.

With reference to the first aspect, or the first implementation manner of the first aspect, or the second implementation manner of the first aspect, in a third implementation manner of the first aspect, after obtaining service consumption feature data, position activity feature data, and social network feature data of a user within a first preset time period, the method further includes reducing a dimension of the position activity feature data to a preset dimension, and calculating influence of the user in the social network according to the social network feature data, and inputting the obtained service consumption feature data, position activity feature data, and social network feature data to a pretrained classifier for calculation and outputting a calculation result, which includes inputting the service consumption feature data, the position activity feature data whose dimension is reduced to the preset dimension, and the influence, which is obtained through calculation, of the user in the social network to the pretrained classifier for calculation and outputting the calculation result.

With reference to the third implementation manner of the first aspect, in a fourth implementation manner of the first aspect, in a process of inputting the service consumption feature data, the position activity feature data whose dimension is reduced to the preset dimension, and the influence, which is obtained through calculation, of the user in the social network to the pretrained classifier for calculation, larger service consumption feature data indicates a smaller user unsubscription probability, greater influence of the user in the social network indicates a smaller user unsubscription probability, less data related to communication between the user and a base station with worse communication quality indicates a smaller user unsubscription probability when the user communicates with different base stations in a same network, and larger data related to communication between the user and a base station indicates a smaller probability that the user unsubscribes from a network at which the base station is located when the user communicates with base stations in different networks.

With reference to the first aspect, or the first implementation manner of the first aspect, or the second implementation manner of the first aspect, or the third implementation manner of the first aspect, or the fourth implementation manner of the first aspect, in a fifth implementation manner of the first aspect, before obtaining service consumption feature data, position activity feature data, and social network feature data of a user within a first preset time period, the method further includes training the classifier, and a specific method is as follows. Setting service consumption feature data, position activity feature data, and social network feature data of each user within a second preset time period as first input of the classifier, setting a current network status of each user as second input of the classifier, and training, using a preset algorithm, the first input and the second input that are input to the classifier, to obtain the classifier, where the second preset time period is greater than the first preset time period, and the preset algorithm includes a random forest algorithm, a Support Vector Machine algorithm, a deep neural network algorithm, and a logistic regression algorithm.

A second aspect of the embodiments of the present application provides a user unsubscription prediction apparatus, including an obtaining unit configured to obtain service consumption feature data, position activity feature data, and social network feature data of a user within a first preset time period, where the position activity feature data refers to data related to communication between the user and each base station within the first preset time period, and the social network feature data refers to data related to communication between the user and another user in a social network within the first preset time period, and a processing unit configured to input the service consumption feature data, the position activity feature data, and the social network feature data that are obtained by the obtaining unit to a pretrained classifier for calculation and output a calculation result, where the calculation result is a user unsubscription prediction result.

With reference to the second aspect, in a first implementation manner of the second aspect, obtaining, by the obtaining unit, position activity feature data of a user within a first preset time period includes extracting, by the obtaining unit, the position activity feature data of the user from a position activity feature matrix, where the position activity feature matrix is a matrix formed of data related to communication between each user and each base station within the first preset time period.

With reference to the second aspect or the first implementation manner of the second aspect, in a second implementation manner of the second aspect, obtaining, by the obtaining unit, social network feature data of a user within a first preset time period includes extracting, by the obtaining unit, the social network feature data of the user from a social network feature matrix, where the social network feature matrix is a matrix formed of data related to communication between users in the social network within the first preset time period.

With reference to the second aspect, or the first implementation manner of the second aspect, or the second implementation manner of the second aspect, in a third implementation manner of the second aspect, the processing unit includes a first processing subunit configured to reduce a dimension of the position activity feature data obtained by the obtaining unit to a preset dimension, a second processing subunit configured to calculate influence of the user in the social network according to the social network feature data obtained by the obtaining unit, and a third processing subunit configured to input the service consumption feature data, the position activity feature data whose dimension is reduced to the preset dimension, and the influence, which is obtained through calculation, of the user in the social network to the pretrained classifier for calculation and output the calculation result.

With reference to the third implementation manner of the second aspect, in a fourth implementation manner of the second aspect, in a process in which the third processing subunit inputs the service consumption feature data, the position activity feature data whose dimension is reduced to the preset dimension, and the influence, which is obtained through calculation, of the user in the social network to the pretrained classifier for calculation, larger service consumption feature data indicates a smaller user unsubscription probability, greater influence of the user in the social network indicates a smaller user unsubscription probability, less data related to communication between the user and a base station with worse communication quality indicates a smaller user unsubscription probability when the user communicates with different base stations in a same network, and larger data related to communication between the user and a base station indicates a smaller probability that the user unsubscribes from a network at which the base station is located when the user communicates with base stations in different networks.

With reference to the second aspect, or the first implementation manner of the second aspect, or the second implementation manner of the second aspect, or the third implementation manner of the second aspect, or the fourth implementation manner of the second aspect, in a fifth implementation manner of the second aspect, the apparatus further includes a classifier training unit configured to train the classifier, and the classifier training unit is configured to set service consumption feature data, position activity feature data, and social network feature data of each user within a second preset time period as first input of the classifier, set a current network status of each user as second input of the classifier, and train, using a preset algorithm, the first input and the second input that are input to the classifier, to obtain the classifier, where the second preset time period is greater than the first preset time period, and the preset algorithm includes a random forest algorithm, a Support Vector Machine algorithm, a deep neural network algorithm, and a logistic regression algorithm.

According to the embodiments of the present application, service consumption feature data, position activity feature data, and social network feature data of a user are obtained, and the three types of data is input to a classifier for user unsubscription prediction. Compared with a method in the prior art that only the service consumption feature data of the user is used to reflect user unsubscription features, the position activity feature data and the social network feature data of the user are added in the embodiments of the present application. The user unsubscription features are fully reflected using the three types of data. Because the user unsubscription prediction is performed according to the three types of data, a prediction result is more reliable and accurate.

### BRIEF DESCRIPTION OF DRAWINGS

To describe the technical solutions in the embodiments of the present application more clearly, the following briefly introduces the accompanying drawings required for describing the embodiments. The accompanying drawings in the following description show merely some embodiments of the present application, and a person of ordinary skill in the art may still derive other drawings from these accompanying drawings without creative efforts.

FIG. 1 is a flowchart diagram of an embodiment of a user unsubscription prediction method according to the present application;

FIG. 2 is a flowchart diagram of another embodiment of a user unsubscription prediction method according to the present application;

FIG. 3 is a schematic structural diagram of an embodiment of a user unsubscription prediction apparatus according to the present application;

FIG. 4 is a schematic structural diagram of another embodiment of a user unsubscription prediction apparatus according to the present application; and

FIG. 5 is a schematic structural diagram of another embodiment of a user unsubscription prediction apparatus according to the present application.

### DESCRIPTION OF EMBODIMENTS

The following describes the technical solutions in the embodiments of the present application with reference to the accompanying drawings in the embodiments of the present application. The described embodiments are merely some but not all of the embodiments of the present application. All other embodiments obtained by a person of ordinary skill in the art based on the embodiments of the present application without creative efforts shall fall within the protection scope of the present application.

Embodiments of the present application provide a user unsubscription prediction method and apparatus in order to accurately predict whether a user unsubscribes in the future.

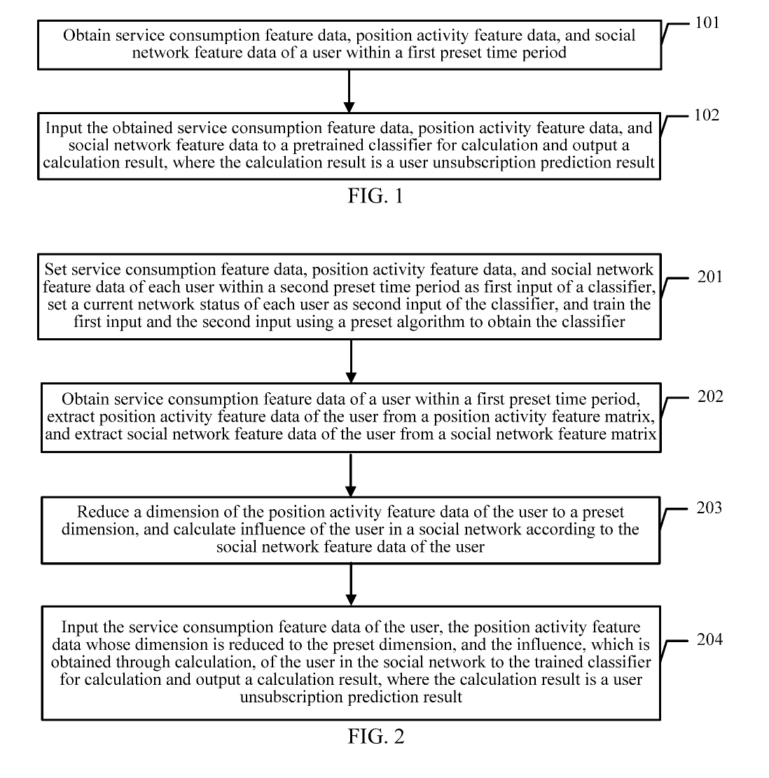

Referring to FIG. 1, an embodiment of a user unsubscription prediction method according to the present application includes the following steps.

Step 101: Obtain service consumption feature data, position activity feature data, and social network feature data of a user within a first preset time period.

The service consumption feature data refers to data shown on a bill and a call detail record of a user, for example, daily call duration, daily used data traffic, and a monthly consumption amount of a user. The position activity feature data refers to data related to communication between the user and each base station within a first preset time period, for example, an identifier of the base station communicating with the user, and a frequency and duration of connection between the user and the base station. The social network feature data refers to data related to communication between the user and another user in a social network within the first preset time period, for example, an identifier of the other user communicating with the user, and duration and a frequency of communication between the user and the other user.

In specific implementation, the service consumption feature data, the position activity feature data, and the social network feature data of the user may be obtained from an operator. The operator includes, but is not limited to, for example, a telecommunications operator, a mobile communications operator, or a unicom operator. The first preset time period, for example, three months or six months, may be preset. Generally, it may be predicted using related data of past M months of the user whether the user unsubscribes in the following N months, where both M and N are positive integers, and M may be greater than or equal to N, or M may be less than N. A prediction result when M is greater than or equal to N is more accurate than a prediction result when M is less than N. Further, M and N may be preset according to an actual need, which is not limited herein.

Step 102: Input the obtained service consumption feature data, position activity feature data, and social network feature data to a pretrained classifier for calculation and output a calculation result, where the calculation result is a user unsubscription prediction result.

In this embodiment of the present application, service consumption feature data, position activity feature data, and social network feature data of a user are obtained, and the three types of data is input to a classifier for user unsubscription prediction. In this embodiment of the present application, user unsubscription features are fully reflected with reference to the position activity feature data and the social network feature data of the user. A prediction result is more reliable and accurate if the user unsubscription prediction is performed according to the three types of data.

For ease of understanding, the following describes the user unsubscription prediction method according to the present application using a specific embodiment. Referring to FIG. 2, the method in this embodiment includes the following steps.

Step 201: Set service consumption feature data, position activity feature data, and social network feature data of each user within a second preset time period as first input of a classifier, set a current network status of each user as second input of the classifier, and train the first input and the second input using a preset algorithm to obtain the classifier.

A classifier f in this embodiment may be a binary classifier. The binary classifier refers to a function in which an input sample feature vector xₙ is mapped to a binary value yₙ={0, 1} and is formed by several parameters. Generally, specific values of the parameters are to be determined and are obtained by means of training.

Training of the classifier f refers to a process of estimating parameters of a function f given that a positive sample and negative sample {xₙ, yₙ} pair is known, where when yₙ=1, a sample xₙ is a positive sample, and when yₙ=0, a sample xₙ is a negative sample.

Further, in this embodiment, a training process of the classifier includes setting service consumption feature data, position activity feature data, and social network feature data of each user within a second preset time period as first input of the classifier, setting a current network status (unsubscribing or subscribing) of each user as second input of the classifier, and training the first input and the second input using a preset algorithm to obtain the classifier, where the preset algorithm includes a random forest algorithm, a Support Vector Machine algorithm, a deep neural network algorithm, a logistic regression algorithm, and the like. That is, in this embodiment, training of the classifier refers to a process of estimating parameters of the function f when input of the classifier f is the service consumption feature data, the position activity feature data, and the social network feature data of each user, and output of the classifier f is the current network status of each user.

Step 202: Obtain service consumption feature data of a user within a first preset time period, extract position activity feature data of the user from a position activity feature matrix, and extract social network feature data of the user from a social network feature matrix.

The service consumption feature data refers to data shown on a bill and a call detail record of the user, for example, daily call duration, daily used data traffic, and a monthly consumption amount of the user. The service consumption feature data may be directly obtained from the bill and the call detail record of the user.

The position activity feature data refers to data related to communication between the user and each base station within the first preset time period, for example, an identifier of the base station communicating with the user, and a frequency and duration of connection between the user and the base station. In this embodiment, data related to communication between each user and each base station within the first preset time period forms a matrix, and the matrix is referred to as a position activity feature matrix. Each element in the matrix represents data related to communication between one user and one base station. Data related to communication between the user and each base station is extracted from the position activity feature matrix and used as the position activity feature data of the user.

The social network feature data refers to data related to communication between the user and another user in a social network within the first preset time period, for example, an identifier of the other user communicating with the user, and duration and a frequency of communication between the user and the other user. In this embodiment, data related to communication between users in the social network within the first preset time period forms a matrix, and the matrix is referred to as a social network feature matrix. Each element in the matrix represents data related to communication between one user and another user. Data related to communication between the user and another user is then extracted from the social network feature matrix and is used as the social network feature data of the user.

In specific implementation, the first preset time period, for example, three months or six months, may be preset. Generally, it may be predicted using related data of past M months of the user whether the user unsubscribes in the following N months, where both M and N are positive integers, and M may be greater than or equal to N, or M may be less than N. A prediction result when M is greater than or equal to N is more accurate than a prediction result when M is less than N. Further, M and N may be preset according to an actual need, which is not limited herein.

In addition, it should be noted that, the second preset time period needs to be greater than the first preset time period.

Step 203: Reduce a dimension of the position activity feature data of the user to a preset dimension, and calculate influence of the user in a social network according to the social network feature data of the user.

Generally, the dimension of the position activity feature data of the user is relatively high, and generally, the dimension M≧10⁵. Therefore, the position activity feature data cannot be directly used. Therefore, in this embodiment, after the position activity feature data of the user is obtained, dimension reduction processing needs to be performed on the position activity feature data. An algorithm for the dimension reduction processing includes, but is not limited to a Principal Component Analysis (PCA) algorithm, a Latent Dirichlet allocation (LDA) algorithm, and a Probabilistic Matrix Factorization (PMF) algorithm. Because the user connects to only some base stations within different time periods, the matrix used to represent the position activity feature data of the user is a sparse matrix, that is, most elements in the matrix are 0. Further, the LDA algorithm may be used to reduce a dimension. The sparse matrix X_{N×M}^{position} used to represent the position activity feature data of the user is factorized into the product of θ_{N×K} and φ_{K×M}, that is, X_{N×M}^{position}≈θ_{N×K}×φ_{K×M}, where K is a value specified by the user, for example, K=100, K is far less than M, and the dimension of the matrix θ_{N×K} is K such that a dimension reduction effect is achieved. Under the function of the LDA algorithm for dimension reduction, the matrix θ_{N×K} is obtained, and the matrix θ_{N×K} is used as the position activity feature data whose dimension is reduced to the preset dimension.

For the social network feature data, influence of the user in the social network may be calculated according to the social network feature data of the user. Because in the social network, the other user communicating with the user generally are only several fixed users, the matrix X_{N×M}^{social networking} used to represent the social network feature data of the user still is a sparse matrix. Most elements in the matrix are 0. Subsequently, the influence of the user in the social network is calculated using a preset influence transfer algorithm. The foregoing influence transfer algorithm includes, but is not limited to a webpage rank (for example PageRank) algorithm, a hyperlink analysis-based topic search (for example Hypertext-Induced Topic Search) algorithm, and a random walk algorithm.

Step 204: Input the service consumption feature data of the user, the position activity feature data whose dimension is reduced to the preset dimension, and the influence, which is obtained through calculation, of the user in the social network to the trained classifier for calculation and output a calculation result, where the calculation result is a user unsubscription prediction result.

In the foregoing calculation process, larger service consumption feature data of the user indicates a smaller user unsubscription probability in the calculation result, greater influence of the user in the social network indicates a smaller user unsubscription probability in the calculation result, less data related to communication between the user and a base station with worse communication quality indicates a smaller user unsubscription probability in the calculation result when the user communicates with different base stations in a same network, and larger data related to communication between the user and a base station indicates a smaller probability that the user unsubscribes from a network at which the base station is located when the user communicates with base stations in different networks.

Because larger service consumption feature data of the user indicates higher user unsubscription costs, the user does not easily cancel a subscription service. Similarly, because greater influence of the user in the social network indicates higher unsubscription costs, the user does not easily cancel a subscription service either. A base station communicating with the user and other related data may be obtained according to the position activity feature data of the user. When the user communicates with different base stations in a same network, for example, the user communicates with three base stations A, B, and C in a same network. It is found through previous investigation and statistics collection that communication quality of the base station A is higher than communication quality of the base station B, and the communication quality of the base station B is higher than a base station C. If the user often communicates with the base station C having an extremely bad communication quality, a service experienced by the user is extremely bad, which finally leads to future unsubscription. On the contrary, if the user often communicates with the base station A, a service experienced by the user is extremely good, and a future unsubscription probability becomes low. When the user communicates with base stations in different networks, for example, in a preset time period, the user ever communicates with a base station A in an X network (a communications network at a place X) and ever communicates with a base station B in a Y network (a communications network at a place Y), where both duration and a frequency of communication between the user and the base station A are decreased compared with those before, and on the contrary, both duration and a frequency of communication between the user and the base station B are increased compared with those before. In this case, the user may move from the place X to the place Y, and therefore, a probability that the user unsubscribes from the X network in the future becomes larger.

In this embodiment, service consumption feature data, position activity feature data, and social network feature data of a user are obtained, and the three types of data is input to a classifier for user unsubscription prediction. Compared with the other approaches, in this embodiment of the present application, user unsubscription features are fully reflected using the service consumption feature data, the position activity feature data, and the social network feature data of the user. A prediction result is more reliable and accurate if user unsubscription prediction is performed according to the three types of data. It is proved by experiments that, if unsubscription prediction is performed using the method in this embodiment, a predicted AUC value is greater than 0.8, where the AUC value refers to an indicator of prediction precision of a classifier, the AUC value is generally greater than 0 and less than 1, and a larger value indicates high prediction precision.

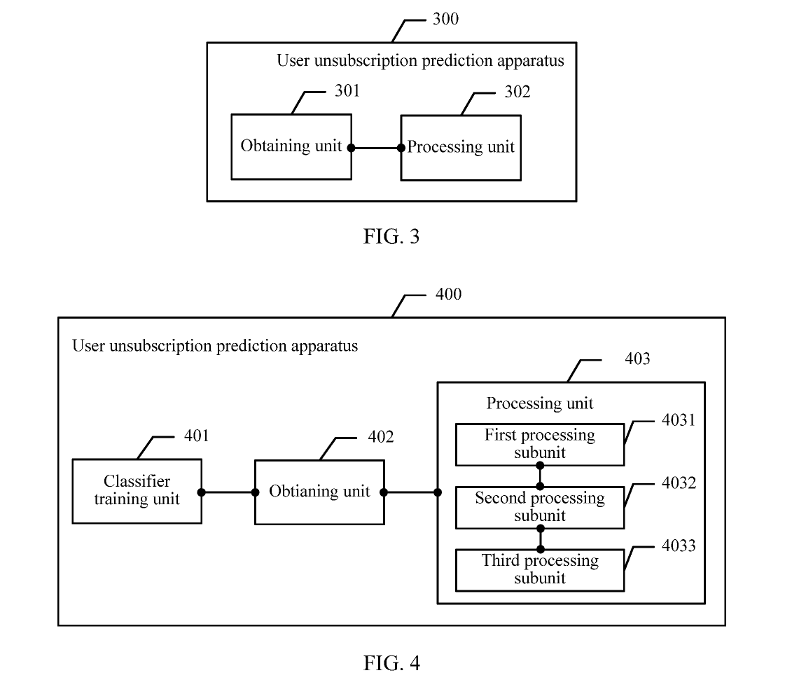

The following describes a user unsubscription prediction apparatus according to an embodiment of the present application. Referring to FIG. 3, a user unsubscription prediction apparatus 300 in this embodiment includes an obtaining unit 301 configured to obtain service consumption feature data, position activity feature data, and social network feature data of a user within a first preset time period, where the position activity feature data refers to data related to communication between the user and each base station within the first preset time period, and the social network feature data refers to data related to communication between the user and another user in a social network within the first preset time period, and a processing unit 302 configured to input the service consumption feature data, the position activity feature data, and the social network feature data that are obtained by the obtaining unit 301 to a pretrained classifier for calculation and output a calculation result, where the calculation result is a user unsubscription prediction result.

For ease of understanding, the following describes the user unsubscription prediction apparatus according to the present application using a specific embodiment. Referring to FIG. 4, a user unsubscription prediction apparatus 400 in this embodiment includes a classifier training unit 401 configured to train the classifier, where the classifier training unit 401 is configured to set service consumption feature data, position activity feature data, and social network feature data of each user within a second preset time period as first input of the classifier, set a current network status of each user as second input of the classifier, and train, using a preset algorithm, the first input and the second input that are input to the classifier, to obtain the classifier, where the second preset time period is greater than a first preset time period, and the preset algorithm includes a random forest algorithm, a Support Vector Machine algorithm, a deep neural network algorithm, and a logistic regression algorithm, an obtaining unit 402 configured to obtain service consumption feature data, position activity feature data, and social network feature data of a user within the first preset time period, and a processing unit 403 configured to input the service consumption feature data, the position activity feature data, and the social network feature data that are obtained by the obtaining unit 402 to a pretrained classifier for calculation and output a calculation result, where the calculation result is a user unsubscription prediction result.

The processing unit 403 includes a first processing subunit 4031 configured to reduce a dimension of the position activity feature data obtained by the obtaining unit 402 to a preset dimension, a second processing subunit 4032 configured to calculate influence of the user in a social network according to the social network feature data obtained by the obtaining unit 402, and a third processing subunit 4033 configured to input the service consumption feature data, the position activity feature data whose dimension is reduced to the preset dimension, and the influence, which is obtained through calculation, of the user in the social network to the pretrained classifier for calculation and output the calculation result.

For further understanding, the following describes, using an actual application scenario, a manner of interaction between units of the user unsubscription prediction apparatus 400 in this embodiment, which is as follows.

First, the classifier training unit 401 sets the service consumption feature data, the position activity feature data, and the social network feature data of each user within the second preset time period as first input of the classifier, set a current network status of each user as second input of the classifier, and train, using a preset algorithm, the first input and the second input that are input to the classifier, to obtain the classifier, where the preset algorithm includes a random forest algorithm, a Support Vector Machine algorithm, a deep neural network algorithm, and a logistic regression algorithm. That is, in this embodiment, training of the classifier refers to a process of estimating parameters of a function f when input of a classifier f is the service consumption feature data, the position activity feature data, and the social network feature data of each user, and output of the classifier f is the current network status of each user.

After the classifier training unit 401 trains the classifier, the obtaining unit 402 obtains the service consumption feature data, the position activity feature data, and the social network feature data of the user within the first preset time period.

The service consumption feature data refers to data shown on a bill and a call detail record of the user, for example, daily call duration, daily used data traffic, and a monthly consumption amount of the user. The service consumption feature data may be directly obtained from the bill and the call detail record of the user.

The position activity feature data refers to data related to communication between the user and each base station within the first preset time period, for example, an identifier of the base station communicating with the user, and a frequency and duration of connection between the user and the base station. In this embodiment, data related to communication between each user and each base station within the first preset time period first forms a matrix, and the matrix is referred to as a position activity feature matrix. Each element in the matrix represents data related to communication between one user and one base station. Then, the obtaining unit 402 extracts data related to communication between the user and each base station from the position activity feature matrix and uses the data as the position activity feature data of the user.

The social network feature data refers to data related to communication between the user and another user in the social network within the first preset time period, for example, an identifier of the other user communicating with the user, and duration and a frequency of communication between the user and the other user. In this embodiment, data related to communication between users in the social network within the first preset time period forms a matrix, and the matrix is referred to as a social network feature matrix. Each element in the matrix represents data related to communication between one user and another user. Then, the obtaining unit 402 extracts data related to communication between the user and another user from the social network feature matrix and uses the data as the social network feature data of the user.

In specific implementation, the first preset time period, for example, three months or six months, may be preset. Generally, it may be predicted using related data of past M months of the user whether the user unsubscribes in the following N months, where both M and N are positive integers, and M may be greater than or equal to N, or M may be less than N. A prediction result when M is greater than or equal to N is more accurate than a prediction result when M is less than N. Further, M and N may be preset according to an actual need, which is not limited herein.

In addition, it should be noted that, the second preset time period needs to be greater than the first preset time period.

The first processing subunit 4031 reduces the dimension of the position activity feature data, which is obtained by the obtaining unit 402, of the user to the preset dimension. The dimension of the position activity feature data of the user is relatively high, and generally, the dimension M≧10⁵. Therefore, the position activity feature data cannot be directly used. Therefore, in this embodiment, after the position activity feature data of the user is obtained, the first processing subunit 4031 needs to perform dimension reduction processing on the position activity feature data. An algorithm for the dimension reduction processing includes, but is not limited to a PCA algorithm, an LDA algorithm, and a PMF algorithm. Because the user connects to only some base stations within different time periods, the matrix used to represent the position activity feature data of the user is a sparse matrix, that is, most elements in the matrix are 0. Further, the LDA algorithm may be used to reduce a dimension. The sparse matrix X_{N×M}^{position} used to represent the position activity feature data of the user is factorized into the product of θ_{N×K} and φ_{K×M}, that is, X_{N×M}^{position}≈θ_{N×K}×φ_{K×M}, where K is a value specified by the user, for example, K=100, K is far less than M, and the dimension of the matrix θ_{N×K} is K such that a dimension reduction effect is achieved. Under the function of the LDA algorithm for dimension reduction, the matrix θ_{N×K} is obtained, and the matrix θ_{N×K} is used as the position activity feature data whose dimension is reduced to the preset dimension.

For the social network feature data, the second processing subunit 4032 may calculate influence of the user in the social network according to the social network feature data of the user. Because in the social network, the other user communicating with the user generally are only several fixed users, the matrix X_{N×M}^{social networking} used to represent the social network feature data of the user still is a sparse matrix. Most elements in the matrix are 0. Then, the second processing subunit 4032 calculates the influence of the user in the social network using a preset influence transfer algorithm. The foregoing influence transfer algorithm includes, but is not limited to a webpage rank (for example PageRank) algorithm, a hyperlink analysis-based topic search (for example Hypertext-Induced Topic Search algorithm), and a random walk algorithm.

The third processing subunit 4033 inputs the service consumption feature data of the user, the position activity feature data whose dimension is reduced to the preset dimension, and the influence, which is obtained through calculation, of the user in the social network to the trained classifier for calculation and outputs the calculation result, where the calculation result is the user unsubscription prediction result.

In the foregoing calculation process, larger service consumption feature data of the user indicates a smaller user unsubscription probability in the calculation result, greater influence of the user in the social network indicates a smaller user unsubscription probability in the calculation result, less data related to communication between the user and a base station with worse communication quality indicates a smaller user unsubscription probability in the calculation result when the user communicates with different base stations in a same network, and larger data related to communication between the user and a base station indicates a smaller probability that the user unsubscribes from a network at which the base station is located when the user communicates with base stations in different networks.

Because larger service consumption feature data of the user indicates higher user unsubscription costs, the user does not easily cancel a subscription service. Similarly, because greater influence of the user in the social network indicates higher unsubscription costs, the user does not easily cancel a subscription service either. A base station communicating with the user and other related data may be obtained according to the position activity feature data of the user. When the user communicates with different base stations in a same network, for example, the user communicates with three base stations A, B, and C in a same network. It is found through previous investigation and statistics collection that communication quality of the base station A is higher than communication quality of the base station B, and the communication quality of the base station B is higher than a base station C. If the user often communicates with the base station C having an extremely bad communication quality, a service experienced by the user is extremely bad, which finally leads to future unsubscription. On the contrary, if the user often communicates with the base station A, a service experienced by the user is extremely good, and a future unsubscription probability becomes low. When the user communicates with base stations in different networks, for example, in a preset time period, the user ever communicates with a base station A in an X network (a communications network at a place X) and ever communicates with a base station B in a Y network (a communications network at a place Y), where both duration and a frequency of communication between the user and the base station A are decreased compared with those before, and on the contrary, both duration and a frequency of communication between the user and the base station B are increased compared with those before. In this case, the user may move from the place X to the place Y, and therefore, a probability that the user unsubscribes from the X network in the future becomes larger.

In this embodiment, the obtaining unit 402 obtains service consumption feature data, position activity feature data, and social network feature data of a user, and the processing unit 403 inputs the three types of data to a classifier for user unsubscription prediction. Compared with the other approaches, in this embodiment of the present application, user unsubscription features are fully reflected using the service consumption feature data, the position activity feature data, and the social network feature data of the user. Because user unsubscription prediction is performed according to the three types of data, a prediction result is more reliable and accurate.

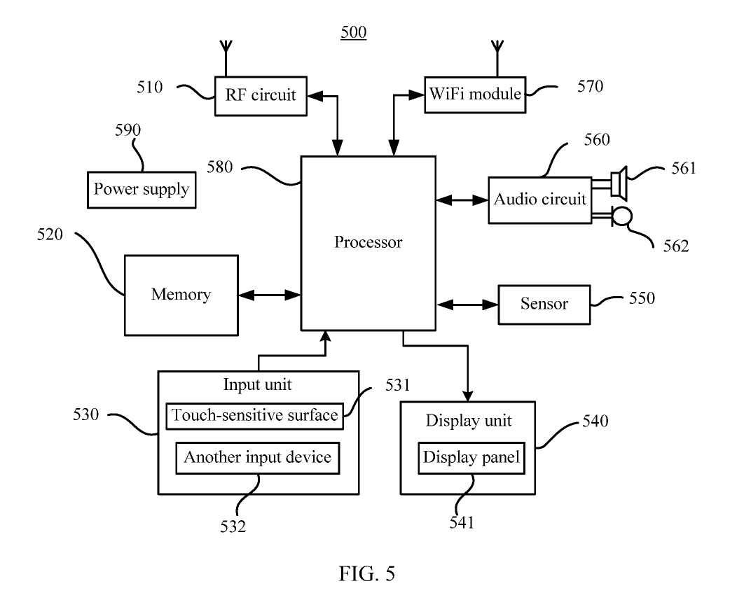

Referring to FIG. 5, FIG. 5 provides a schematic diagram of another embodiment of a user unsubscription prediction apparatus 500 according to the present application. The user unsubscription prediction apparatus 500 in this embodiment may be used to implement the user unsubscription prediction method provided in the foregoing embodiment. In an actual application, the user unsubscription prediction apparatus 500 may be integrated into an electronic device, and the electronic device may be a computer or the like.

The user unsubscription prediction apparatus 500 may include components such as an radio frequency (RF) circuit 510, a memory 520 including one or more computer readable storage mediums, an input unit 530, a display unit 540, a sensor 550, an audio circuit 560, a WiFi module 570, a processor 580 including one or more processing cores, and a power supply 590. A person skilled in the art may understand that, a structure shown in FIG. 5 does not constitute any limitation to the user unsubscription prediction apparatus 500 and the user unsubscription prediction apparatus 500 may include more or less components than components shown in the figure, or a combination of some components, or different component deployments.

The RF circuit 510 may be configured to receive and send signals during an information receiving and sending process or a call process, particularly, after receiving downlink information of a base station, deliver the downlink information of the base station to the one or more processors 580 for processing, and in addition, send related uplink data to the base station. Generally, the RF circuit 510 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 510 may further communicate with a network and another device by means of wireless communication. The wireless communication may use any communications standard or protocol, including but not limited to Global System for Mobile Communications (GSM), General Packet Radio Service (GPRS), Code Division Multiple Access (CDMA), Wideband Code Division Multiple Access (WCDMA), Long Term Evolution (LTE), electronic mail (e-mail), and SMS.

The memory 520 may be configured to store a software program and module. The processor 580 runs the software program and module stored in the memory 520, to implement various functional applications and data processing. The memory 520 may mainly include a program storage area and a data storage area, where the program storage area may store an operating system, an application program (such as a voice playing function and an image playing function) needed by at least one function, and the data storage area may store data (such as audio data, and a phone book) established according to using of a storage device. In addition, the memory 520 may include a high-speed random access memory (RAM), and may also include a non-volatile memory, for example, at least one magnetic disk memory device, a flash memory device, or another volatile solid-state memory device. Correspondingly, the memory 520 may further include a memory controller in order to provide access of the processor 580 and the input unit 530 to the memory 520.

The input unit 530 may be configured to receive input figure or character information, and generate a keyboard, mouse, joystick, optical or trackball signal input related to a user setting and function control. Further, the input unit 530 may include a touch-sensitive surface 531 and another input device 532. The touch-sensitive surface 531, which may also be referred to as a touch display screen or a touch panel, may collect a touch operation of a user on or near the touch-sensitive surface 531 (such as an operation of a user on or near the touch-sensitive surface 531 using any suitable object or attachment, such as a finger or a touch pen), and drive a corresponding connection apparatus according to a preset program. Optionally, the touch-sensitive surface 531 may include two parts, a touch detection apparatus and a touch controller. The touch detection apparatus detects a touch location of the user, detects a signal generated by the touch operation, and transfers the signal to the touch controller. The touch controller receives touch information from the touch detection apparatus, converts the touch information into touch point coordinates, and then sends the touch point coordinates to the processor 580. Moreover, the touch controller can receive and execute a command sent from the processor 580. In addition, the touch-sensitive surface 531 may be a resistive, capacitive, infrared, or surface sound wave type touch-sensitive surface. In addition to the touch-sensitive surface 531, the input unit 530 may further include the other input device 532. Further, the other input device 532 may include, but is not limited to, one or more of a physical keyboard, a functional key (such as a volume control key or a switch key), a trackball, a mouse, and a joystick.

The display unit 540 may be configured to display information input by the user or information provided for the user, and various graphical user interfaces of the apparatus 500. These graphical user interfaces may be formed by a graph, a text, an icon, a video, or any combination thereof. The display unit 540 may include a display panel 541. Optionally, the display panel 541 may be configured using a Liquid Crystal Display (LCD), an Organic Light-Emitting Diode (OLED), or the like. Further, the touch-sensitive surface 531 may cover the display panel 541. After detecting a touch operation on or near the touch-sensitive surface 531, the touch-sensitive surface 531 transfers the touch operation to the processor 580 in order to determine the type of the touch event. Then, the processor 580 provides a corresponding visual output on the display panel 541 according to the type of the touch event. Although, in FIG. 5, the touch-sensitive surface 531 and the display panel 541 are used as two separate components to implement input and output functions, in some embodiments, the touch-sensitive surface 531 and the display panel 541 may be integrated to implement the input function and output functions.

The user unsubscription prediction apparatus 500 may further include at least one sensor 550, such as an optical sensor, a motion sensor, and other sensors. Further, the optical sensor 550 may include an ambient light sensor and a proximity sensor, where the ambient light sensor may adjust luminance of the display panel 541 according to brightness of the ambient light. The proximity sensor may switch off the display panel 541 and/or backlight when the apparatus 500 is moved to the ear. As one type of motion sensor, a gravity acceleration sensor may detect magnitude of accelerations in various directions (generally on three axes), may detect magnitude and a direction of the gravity when static, and may be configured to identify an application of an apparatus gesture (such as switchover between horizontal and vertical screens, a related game, and gesture calibration of a magnetometer), a function related to vibration recognition (such as a pedometer and a knock), and the like. Other sensors, such as a gyroscope, a barometer, a hygrometer, a thermometer, and an infrared sensor, which may be configured in the apparatus 500 are not further described herein.

The audio circuit 560, a speaker 561, and a microphone 562 may provide audio interfaces between the user and the apparatus. The audio circuit 560 may convert received audio data into an electric signal and transmit the electric signal to the speaker 561. The speaker 561 converts the electric signal into a sound signal for output. On the other hand, the microphone 562 converts a collected sound signal into an electric signal. The audio circuit 560 receives the electric signal and converts the electric signal into audio data, and outputs the audio data to the processor 580 for processing. Then, the processor 180 sends the audio data to, for example, another apparatus using the RF circuit 510, or outputs the audio data to the memory 520 for further processing. The audio circuit 560 may further include an earplug jack in order to provide communication between a peripheral earphone and the apparatus.

WiFi is a short distance wireless transmission technology. The user unsubscription prediction apparatus 500 may help, using the WiFi module 570, a user to receive and send an e-mail, browse a webpage, and access stream media, and the like, which provides wireless broadband Internet access for the user. Although FIG. 5 shows the WiFi module 570, it may be understood that the WiFi module 570 is not a necessary component of the mobile phone, and when needed, the WiFi module 570 may be omitted as long as the scope of the essence of the present application is not changed.

The processor 580 is a control center of the user unsubscription prediction apparatus 500, and connects to various parts of the apparatus 500 using various interfaces and lines. By running or executing the software program and/or module stored in the memory 520, and invoking data stored in the memory 520, the processor 580 performs various functions and data processing of the storage device, thereby performing overall monitoring on the storage device. Optionally, the processor 580 may include the one or more processing cores. Preferably, the processor 580 may integrate an application processor and a modem. The application processor mainly processes an operating system, a user interface, an application program, and the like. The modem mainly processes wireless communication. It may be understood that the foregoing modem may also not be integrated into the processor 580.

The user unsubscription prediction apparatus 500 further includes the power supply 590 (such as a battery) for supplying power to the components. Preferably, the power supply may logically connect to the processor 580 using a power supply management system, thereby implementing functions, such as charging, discharging, and power consumption management, using the power supply management system. The power supply 590 may further include one or more of a direct current or alternate current power supply, a re-charging system, a power supply fault detection circuit, a power supply converter or an inverter, a power supply state indicator, and any other components.

Although not shown in the figure, the user unsubscription prediction apparatus 500 may further include a camera, a BLUETOOTH module, and the like, and details are not described herein. Further, in this embodiment, the user unsubscription prediction apparatus 500 further includes a memory 520, and one or more programs, where the one or more programs are stored in the memory 520 and the one or more processors 580 are configured to execute the one or more programs to perform the operations of obtaining service consumption feature data, position activity feature data, and social network feature data of a user within a first preset time period, where the position activity feature data refers to data related to communication between the user and each base station within the first preset time period, and the social network feature data refers to data related to communication between the user and another user in a social network within the first preset time period, and inputting the obtained service consumption feature data, position activity feature data, and social network feature data to a pretrained classifier for calculation and outputting a calculation result, where the calculation result is a user unsubscription prediction result.

Optionally, obtaining position activity feature data of a user within a first preset time period includes extracting the position activity feature data of the user from a position activity feature matrix, where the position activity feature matrix is a matrix formed of data related to communication between each user and each base station within the first preset time period.

Optionally, obtaining social network feature data of a user within a first preset time period includes extracting the social network feature data of the user from a social network feature matrix, where the social network feature matrix is a matrix formed of data related to communication between users in the social network within the first preset time period.

Optionally, after obtaining the service consumption feature data, position activity feature data, and social network feature data of a user within a first preset time period, the method further includes reducing a dimension of the position activity feature data to a preset dimension, and calculating influence of the user in the social network according to the social network feature data, and inputting the obtained service consumption feature data, position activity feature data, and social network feature data to a pretrained classifier for calculation and outputting a calculation result includes inputting the service consumption feature data, the position activity feature data whose dimension is reduced to the preset dimension, and the influence, which is obtained through calculation, of the user in the social network to the pretrained classifier for calculation and outputting the calculation result.

Optionally, in a process of inputting the service consumption feature data, the position activity feature data whose dimension is reduced to the preset dimension, and the influence, which is obtained through calculation, of the user in the social network to the pretrained classifier for calculation, larger service consumption feature data indicates a smaller user unsubscription probability, greater influence of the user in the social network indicates a smaller user unsubscription probability, less data related to communication between the user and a base station with worse communication quality indicates a smaller user unsubscription probability when the user communicates with different base stations in a same network, and larger data related to communication between the user and a base station indicates a smaller probability that the user unsubscribes from a network at which the base station is located when the user communicates with base stations in different networks.

Optionally, before obtaining service consumption feature data, position activity feature data, and social network feature data of a user within a first preset time period, the method further includes training the classifier, and a specific method is as follows. Setting service consumption feature data, position activity feature data, and social network feature data of each user within a second preset time period as first input of the classifier, setting a current network status of each user as second input of the classifier, and training, using a preset algorithm, the first input and the second input that are input to the classifier, to obtain the classifier, where the second preset time period is greater than the first preset time period, and the preset algorithm includes a random forest algorithm, a Support Vector Machine algorithm, a deep neural network algorithm, and a logistic regression algorithm.

It should be noted that, the user unsubscription prediction apparatus 500 provided in this embodiment of the present application may be further configured to implement another function in the foregoing apparatus embodiment, and details are not described herein.

In addition, it should be noted that the described apparatus embodiment is merely exemplary. The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments. In addition, in the accompanying drawings of the apparatus embodiments provided by the present application, connection relationships between the modules indicate that the modules have communication connections with each other, which may be further implemented as one or more communications buses or signal cables. A person of ordinary skill in the art may understand and implement the embodiments of the present application without creative efforts.

Based on the description of the foregoing implementation manners, a person skilled in the art may clearly understand that the present application may be implemented by software in addition to necessary universal hardware, or by dedicated hardware, including an application-specific integrated circuit, a dedicated central processing unit (CPU), a dedicated memory, a dedicated component, and the like. Generally, any functions that can be performed by a computer program can be easily implemented using corresponding hardware. Moreover, a specific hardware structure used to achieve a same function may be of various forms, for example, in a form of an analog circuit, a digital circuit, a dedicated circuit, or the like. However, as for the present application, software program implementation is a better implementation manner in most cases. Based on such an understanding, the technical solutions of the present application essentially or the part contributing to the prior art may be implemented in a form of a software product. The computer software product is stored in a readable storage medium, such as a floppy disk, a universal serial bus (USB) flash drive, a removable hard disk, a Read-Only Memory (ROM), a RAM, a magnetic disk, or an optical disc of a computer, and includes several instructions for instructing a computer device (which may be a personal computer, a server, a network device, and the like) to perform the methods described in the embodiments of the present application.

The above describes the user unsubscription prediction method and apparatus provided in the embodiments of the present application in detail. A person of ordinary skill in the art may, based on the idea of the embodiments of the present application, make modifications with respect to the specific implementation manners and the application scope. Therefore, the content of this specification shall not be construed as a limitation to the present application.

What is claimed is:

1. A user unsubscription prediction method, comprising:
obtaining service consumption feature data, position activity feature data, and social network feature data of a user within a first preset time period, wherein the position activity feature data refers to data related to communication between the user and each base station within the first preset time period, and wherein the social network feature data refers to data related to communication between the user and another user in a social network within the first preset time period; and
inputting the obtained service consumption feature data, the position activity feature data, and the social network feature data to a pretrained classifier for calculation and outputting a calculation result, wherein the calculation result is a user unsubscription prediction result.

2. The method according to claim 1, wherein obtaining the position activity feature data of the user within the first preset time period comprises extracting the position activity feature data of the user from a position activity feature matrix, wherein the position activity feature matrix is a matrix formed of data related to communication between each user and each base station within the first preset time period.

3. The method according to claim 1, wherein obtaining the social network feature data of the user within the first preset time period comprises extracting the social network feature data of the user from a social network feature matrix, wherein the social network feature matrix is a matrix formed of data related to communication between users in the social network within the first preset time period.

4. The method according to claim 1, wherein after obtaining the service consumption feature data, the position activity feature data, and the social network feature data of the user within the first preset time period, the method further comprises:
reducing a dimension of the position activity feature data to a preset dimension; and
calculating influence of the user in the social network according to the social network feature data, and
wherein inputting the obtained service consumption feature data, the position activity feature data, and the social network feature data to the pretrained classifier for calculation and outputting the calculation result comprises inputting the service consumption feature data, the position activity feature data whose dimension is reduced to the preset dimension, and the influence, which is obtained through calculation, of the user in the social network to the pretrained classifier for calculation and outputting the calculation result.

5. The method according to claim 4, wherein larger service consumption feature data indicates a smaller user unsubscription probability, wherein greater influence of the user in the social network indicates the smaller user unsubscription probability, wherein less data related to communication between the user and a base station with worse communication quality indicates the smaller user unsubscription probability when the user communicates with different base stations in a same network, and wherein larger data related to communication between the user and another base station indicates a smaller probability that the user unsubscribes from a network at which the other base station is located when the user communicates with the other base stations in different networks.

6. The method according to claim 1, wherein before obtaining the service consumption feature data, the position activity feature data, and the social network feature data of the user within the first preset time period, the method further comprises training the classifier in the following manner:
setting service consumption feature data, position activity feature data, and social network feature data of each user within a second preset time period as first input of the classifier;
setting a current network status of each user as second input of the classifier; and
training, using a preset algorithm, the first input and the second input that are input to the classifier, to obtain the classifier, wherein the second preset time period is greater than the first preset time period, and wherein the preset algorithm comprises a random forest algorithm, a Support Vector Machine algorithm, a deep neural network algorithm, and a logistic regression algorithm.

7. A user unsubscription prediction apparatus, comprising:
a memory; and
a processor coupled to the memory and configured to:
obtain service consumption feature data, position activity feature data, and social network feature data of a user within a first preset time period, wherein the position activity feature data refers to data related to communication between the user and each base station within the first preset time period, and wherein the social network feature data refers to data related to communication between the user and another user in a social network within the first preset time period; and
input the service consumption feature data, the position activity feature data, and the social network feature data to a pretrained classifier for calculation and output a calculation result, wherein the calculation result is a user unsubscription prediction result.

8. The apparatus according to claim 7, wherein when obtaining the position activity feature data of the user within the first preset time period, the processor is further configured to extract the position activity feature data of the user from a position activity feature matrix, wherein the position activity feature matrix is a matrix formed of data related to communication between each user and each base station within the first preset time period.

9. The apparatus according to claim 7, wherein when obtaining the social network feature data of the user within the first preset time period, the processor is further configured to extract the social network feature data of the user from a social network feature matrix, wherein the social network feature matrix is a matrix formed of data related to communication between users in the social network within the first preset time period.

10. The apparatus according to claim 7, wherein the processor is further configured to:
reduce a dimension of the position activity feature data to a preset dimension;
calculate influence of the user in the social network according to the social network feature data; and
input the service consumption feature data, the position activity feature data whose dimension is reduced to the preset dimension, and the influence, which is obtained through calculation, of the user in the social network to the pretrained classifier for calculation and output the calculation result.

11. The apparatus according to claim 10, wherein larger service consumption feature data indicates a smaller user unsubscription probability, wherein greater influence of the user in the social network indicates the smaller user unsubscription probability, wherein less data related to communication between the user and a base station with worse communication quality indicates the smaller user unsubscription probability when the user communicates with different base stations in a same network, and wherein larger data related to communication between the user and another base station indicates a smaller probability that the user unsubscribes from a network at which the other base station is located when the user communicates with the other base stations in different networks.

12. The apparatus according to claim 7, wherein the processor is further configured to:
set service consumption feature data, the position activity feature data, and the social network feature data of each user within a second preset time period as first input of the classifier;
set a current network status of each user as second input of the classifier; and
train, using a preset algorithm, the first input and the second input that are input to the classifier, to obtain the classifier, wherein the second preset time period is greater than the first preset time period, and wherein the preset algorithm comprises a random forest algorithm, a Support Vector Machine algorithm, a deep neural network algorithm, and a logistic regression algorithm.
